(19) United States
(12) Patent Application Publication
(10) Pub. No.: US 2024/0122327 A1
(43) Pub. Date: Apr. 18, 2024

(54) DEVICE FOR THE ELECTRICAL CONNECTION OF HAIR-CARE HOUSEHOLD APPLIANCES OR ELECTRICAL APPARATUSES

(71) Applicant: LIGO PATENTS SA, Ligometta (Mendrisio) (CH)

(72) Inventors: Claudio SORESINA, Cotdrerio (CH); Flavio SORESINA, Mendrisio (CH)

(21) Appl. No.: 18/276,241

(22) PCT Filed: Feb. 23, 2022
(86) PCT No.: PCT/IB2022/051571

§ 371 Date: Aug. 7, 2023

(30) Foreign Application Priority Data
Feb. 24, 2021 (IT) 102021000004271

(51) Int. Cl. A45D 20/12

(52) U.S. Cl. CPC A45D 20/12

(57) ABSTRACT

A device for the electrical connection (10) of hair-care household appliances or electrical apparatuses is described, comprising:
a female receptacle (2), provided with two seats (8a, 8b) connected electrically to a first power cable (17);
a male connector (3) comprising a first electrical contact means (4a) with a longitudinal axis (A-A), comprising a pin (4a′), a second electrical contact means (4b) comprising a tubular element (4b′), and a protection base (5) from which the first electrical contact means (4a) and the second electrical contact means (4b) extend and are fastened, said protection base (5) being coupled to a second power cable (18), which is configured to electrically connect said first electrical contact means (4a) and said second electrical contact means (4b);
the first electrical contact means (4a) and the second electrical contact means (4b) are concentric to each other and can be removably inserted inside said seats (8a, 8b) so as to allow the continuous rotation of the male connector (3) with respect to the female receptacle (2) around the longitudinal axis (A-A);
a protection body (7) configured to contain said female receptacle (2) and at least partially said male connector (3); said protection body (7) being rotatably coupled to said protection base (5) and comprising an outlet (24) for said first power cable (17);
characterised by comprising a barrier element (13) interposed between said pin (4a′) and said outlet (24).

### FIELD OF THE INVENTION

The present invention refers to the field of devices for the electrical connection of hair-care household appliances or electrical apparatuses, such as e.g. hair dryers. More particularly, the present invention concerns a device for the electrical connection of hair-care household appliances or electrical apparatuses configured to prevent the twisting of the power cable.

### KNOWN ART

As known, hair-care household appliances or electrical apparatuses can be equipped, in order to allow their operation, with an electric power cable. During use, the hair-care household appliance or electrical tool is displaced in the space; especially in the case of household appliance or electrical apparatuses for professional use, the cable, being connected to the tool, follows it during the various spatial movements, thus tangling on itself. This results in a twisting of the cable, with a possible tangled mass of knots along its extension.

This situation can involve mechanical stress, in particular torsion and/or bending stress, which typically occurs in the proximity of the point of insertion of the cable into the household appliance or electrical tool, as a result of the aforesaid tangling action.

The Applicant observed that wear and tear of the insulating layer of the cable, which can bring the conductor wires dangerously into view, is not unusual as a result of these stresses.

The Applicant also observed that the formation of said tangled mass of knots along the cable can also limit the freedom of movement of the household appliance or the electrical tool and, consequently, the user.

In order to try to solve the above-mentioned problems, a device was proposed for the electrical connection of household appliances or electrical apparatuses, such as that described in EP2258028.

EP2258028 describes, in fact, a device for the electrical connection of household appliances or electrical apparatuses, comprising a female receptacle provided with two seats, a male connector provided with electrical contact means concentric to each other. The male connector can be removably inserted into the female receptacle so as to allow a continuous rotation of the male connector with respect to the female receptacle.

The Applicant observed that although the device described in EP2258028 brilliantly solves the problem of entanglement of the power cable, it has dimensions that are not negligible in the case of a hair dryer. In particular in professional use, the same device is arranged, in operation, beside the head of the user's customer and its dimensions could make it feel uncomfortable.

The Applicant has further observed that the reduction in the dimensions of the device, during the assembly thereof or by accidental detachment in use, could dangerously bring the electric wires and/or the rheophores inside the power cable against the female receptacle, leading to a deterioration of its operation or the creation of voltaic arcs between the electric wires and the female receptacle and/or male connector.

Therefore, the Applicant raised the problem of implementing a device for the electrical connection of household appliances or electrical apparatuses of small dimensions which in any case protects the female receptacle and/or the male connector from possible contact with the electric wires of the power cable during the assembly of the same device.

The Applicant also raised the problem of implementing a device for the electrical connection of household appliances or electrical apparatuses of small dimensions which allows to increase the safety of the female receptacle or the male connector against possible voltaic arcs which can be generated inside the same device.

### SUMMARY OF THE INVENTION

Therefore the invention, in a first aspect thereof, relates to a device for the electrical connection of hair-care household appliances or electrical apparatuses, comprising:
a female receptacle provided with two seats electrically connected to a first power cable, by means of two conductive contact portions of the same first cable, having mutually different electric potential;
a male connector comprising a first electrical contact means with a longitudinal axis, comprising a pin, a second electrical contact means comprising a tubular portion, and a base from which the first electrical contact means and the second electrical contact means extend and are fastened, said protection base being coupled to a second power cable, which is configured to electrically connect said first electrical contact means and said second electrical contact means;
the first electrical contact means and the second electrical contact means are concentric to each other and can be removably inserted inside said seats so as to allow the continuous rotation of the male connector with respect to the female receptacle around the longitudinal axis;
a protection body configured to contain said female receptacle and at least partially said male connector; said protection body being rotatably coupled to said protection base and comprising an outlet for said first power cable;
characterised by comprising a barrier element interposed between said pin and said outlet, said barrier element being further interposed in a direction transverse to the longitudinal axis between said pin and one of said conductive contact portions so as to electrically shield at least said pin and at least one of said conductive contact portions with respect to a possible voltaic arc generated therebetween.

The present invention, in the aforesaid aspect, may have at least one of the preferred features described hereunder.

Advantageously, the barrier element is away from the pin.

Preferably, the barrier element is shaped to have a vertical extension surface greater than that of the aforesaid pin and the two conductive contact portions.

Preferably, the barrier element comprises a front portion extending transversely to the longitudinal axis.

Conveniently, the front portion of the barrier element has a minimum width, measured along a direction transverse to said longitudinal axis, greater than 3 mm.

Advantageously, the front portion of the barrier element is arranged so as to form a concavity facing the aforesaid pin.

Preferably, the front portion has a minimum height greater than 10 mm.

Advantageously, the front portion has a minimum thickness greater than or equal to 0.5 mm.

Preferably, the barrier element comprises a side portion.

Conveniently, the side portion of the barrier element extends from one end of the front portion along a direction parallel to the longitudinal axis.

Preferably, the barrier element is made of an insulating and heat-resistant plastic material.

Advantageously, the device comprises, at the outlet of the first power cable, anti-intrusion means configured to prevent the insertion of metal objects inside the protection body.

According to another aspect, the present invention concerns a hair dryer equipped with an electrical connection device as described above.

Further characteristics and advantages of the invention will become clearer from the detailed description of some preferred, but not exclusive, embodiments of a device for the electrical connection of hair-care household appliances according to the present invention.

### BRIEF DESCRIPTION OF THE DRAWINGS

Such description will be set forth hereinafter with reference to the appended drawings provided for indicative, and therefore non-limiting, purpose only, wherein:

FIG. 1 shows a schematic front view of a device for the electrical connection of hair-care household appliances or electrical apparatuses according to the present invention;

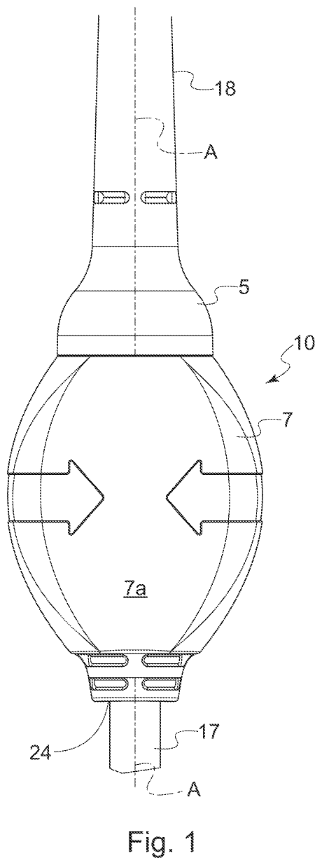

FIG. 2 shows a schematic perspective view with a half-shell removed of the device of FIG. 1;

FIG. 3 shows a schematic front sectional view of the device for the electrical connection of household appliances or electrical apparatuses of FIG. 1; and

FIG. 4 shows a schematic side sectional view of the device for the electrical connection of household appliances or electrical apparatuses of FIG. 1.

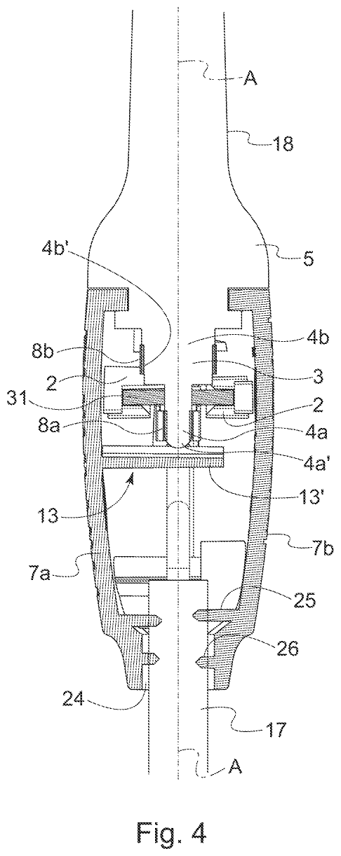

### DETAILED DESCRIPTION OF EMBODIMENTS OF THE INVENTION

With reference to the figures, a device for the electrical connection of hair-care household appliances or electrical apparatuses according to the present invention, is denoted by the reference numeral 10.

The device for the electrical connection of household appliances or electrical apparatuses comprises a female receptacle 2 connected to a first electric power cable 17 provided with two conductive contact portions 17′, a male connector 3, in turn connected to a second electric power cable 18, the connector 3 can be removably inserted inside the female receptacle 2.

The male connector 3 is provided with a first electrical contact means 4a extending along a longitudinal axis A-A and comprising a pin 4a′, and with a second electrical contact means 4b comprising a tubular element 4b′.

The male connector 3 is further provided with a protection base 5 of plastic material 5, from which the first electrical contact means 4a and the second electrical contact means 4b extend and are fastened.

The first electrical contact means 4a and the second electrical contact means 4b are concentric to each other.

In the embodiment shown in the figures, the first electrical contact means 4a and the second electrical contact means 4b extend from the protection base 5 along the longitudinal axis A-A so that the pin 4a′ protrudes with respect to the tubular element 4b′.

The protection base 5 is coupled to the second electric cable 18 configured to electrically connect the first electrical contact means 4a and the second electrical contact means 4b.

The second electric power cable 18 extends from the protection base 5 to connect and power a hair-care household appliance or electrical apparatuses, such as e.g. a hair dryer not shown in the figures.

The first electric power cable 17 extends instead from the female receptacle 2 to connect to a plug (not shown in the figure) to be inserted in a special electric socket in order to power the same female receptacle.

The female receptacle 2 comprises two seats 8a, 8b of metal nature, which are configured to couple to the two conductive contact portions 17′.

In the embodiment shown in the figures, the two seats consist of two retaining springs 8a, 8b adapted to conduct the current and have a substantially cylindrical shape and have suitable elastic properties.

The two seats 8a, 8b have a circular cross-section with such a radius as to allow the insertion and disengagement of the pin 4a and the tubular element 4b.

The first electrical contact means 4a and the second electrical contact means 4b can be removably inserted inside the two seats 8a, 8b so as to allow the continuous rotation of the male connector 3 with respect to the female receptacle 2 around the longitudinal axis A-A.

The connector 10 according to the present invention further comprises a protection body 7 configured to contain the female receptacle 2 and, at least partially, the male connector 3.

The protection body 7, in particular, is rotatably coupled to the protection base 5 so as to allow the continuous rotation of the protection body 7 with respect to the protection base 5.

The protection body 7 has at one end a portion for coupling to the protection base 5 and, at an opposite end, an outlet 24 for the first electric power cable 17.

The protection body 7 is made of plastic material.

Preferably, the protection body is made of two half-shells 7a, 7b joined together through special threaded seats 21 and screws 22.

According to an important aspect of the present invention, the device 10 for the electrical connection of hair-care household appliances or electrical apparatuses has a barrier element 13 interposed between the first contact means 4a and the first electric power cable 17.

In particular, the barrier element 13 is interposed in a direction transverse to the longitudinal axis A-A between the first contact means 4a and one of the two conductive contact portions 17′.

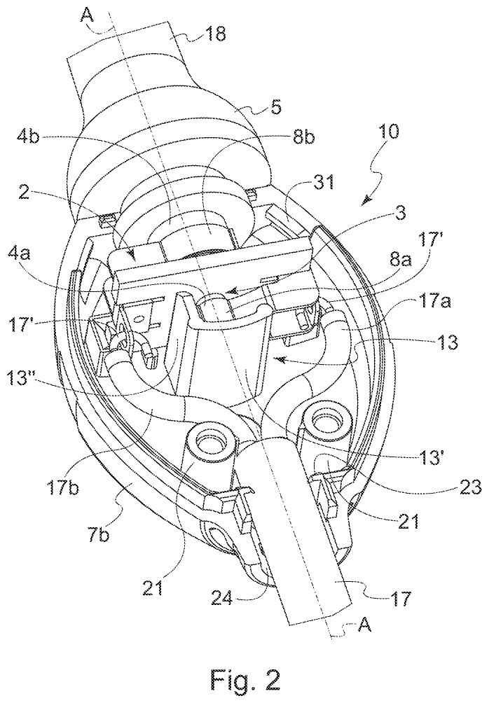

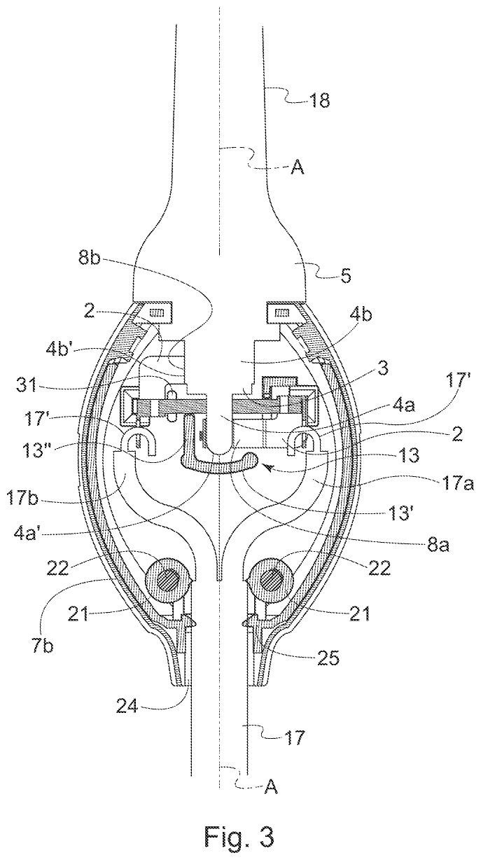

The barrier element 13 is interposed in a direction transverse to the longitudinal axis A-A between the first contact means 4a and the rheophore or inner cable of the first electric cable 17 with different electric potential, depicted in FIGS. 2 and 3 by the rheophore or inner cable of the cable portion 17b.

In FIGS. 2 and 3, the cable 17b is in fact the cable with an electric potential different from the electric potential of the pin 4a, by way of example if the pin 4a has a positive electric potential, the cable 17b has a negative electric potential.

In detail, the barrier element 13 is further interposed in a direction transverse to the longitudinal axis A-A between the pin 4a′ and one of the conductive contact portions 17′ so as to electrically shield at least the pin 4a′ and at least one of the conductive contact portions 17′ against to a possible voltaic arc generated therebetween.

The barrier element 13 is away from the free end of the pin 4a′ of the first contact means 4a.

The barrier element 13 is shaped to have an extension surface in a direction orthogonal to the bottom of the protection body 7, i.e. to the bottom of the half-shell 7b, greater than that of the pin 4a and the two conductive contact portions 17′.

In other words, the barrier element has a surface extension such as to shield the pin 4a and at least one of the two conductive contact portions 17′.

This way, the pin 4a and the conductive contact portion 17′ with different potential with respect to the pin 4a, as defined in technical jargon, are not in contact.

Moreover, the two conductive contact portions 17′, which are also with electric potential different from each other, are not in contact and have therefore mutually different electric potential.

The barrier element 13 comprises a front portion 13′ which extends transversely to the longitudinal axis A-A.

The front portion 13′ of the barrier element 13 has a minimum width measured in plan along the direction transverse to the longitudinal axis A-A such as to cover the first contact means 4a.

Preferably, the front portion 13′ of the barrier element 13 has a minimum width measured in plan along the direction transverse to the longitudinal axis A-A greater than 3 mm, preferably greater than 5 mm.

The front portion 13′ of the barrier element 13 has a minimum height greater than 10 mm, preferably greater than 13 mm.

The front portion 13′ of the barrier element 13 has a minimum height such as to cover the first contact means 4a.

In other words, the first contact means 4a must have a height less than the front portion 13′.

The front portion 13′ of the barrier element 13 has a continuous surface and a substantially rectangular shape.

In the embodiment shown in the figures, the front portion 13′ of the barrier element 13 is arranged so as to form a concavity facing the pin 4a′, so as to direct the electric cables 17a, 17b, accidentally detached in use or inadvertently directed during the assembly against the male connector 3 or the female receptacle 2 outwards, i.e. away from the longitudinal axis A-A.

The front portion 13′ of the barrier element 13 has a minimum thickness greater than or equal to 0.5 mm, preferably greater than or equal to 1 mm.

The Applicant believes that this minimum thickness is the minimum required to protect in particular the male connector 3 against possible voltaic arcs that can be inadvertently generated with the electric cables 17a,17b.

Preferably, the front portion 13′ of the barrier element 13 has a thickness substantially constant along its extension.

The front portion 13′ extends from a half-shell 7b substantially along a direction orthogonal to the direction of the longitudinal axis A-A.

In the embodiment shown in the figures, the front portion 13′ is made in one piece, preferably by moulding with the half-shell 7b.

The barrier element 13 further has a side protection 13″ which extends along a direction parallel to the longitudinal axis A-A from one end of the front portion 13′.

The side protection 13″ extends along a direction parallel to the longitudinal axis A-A for a minimum extension dimension greater than 3 mm, preferably greater than 5 mm.

Preferably, the side protection 13″ extends along a direction parallel to the longitudinal axis A-A so as to come into contact with the panel 31.

The side portion 13″ of the barrier element 13 has a minimum height greater than 10 mm, preferably greater than 13 mm.

The side portion 13″ of the barrier element 13 has a minimum height such as to cover the first contact means 4a laterally.

Preferably, the side portion 13″ of the barrier element 13 has a continuous surface.

The side portion 13″ of the barrier element 13 has a minimum thickness greater than or equal to 0.5 mm, preferably greater than or equal to 1 mm.

Preferably, the side portion 13″ of the barrier element 13 has a thickness substantially constant along its extension.

In the embodiment shown in the figures, the side portion 13″ is made of one piece, preferably by moulding, with the half-shell 7b and the front portion 13′.

The barrier element 13 is made of a heat-resistant plastic material.

Preferably, the barrier element 13 is made of a heat-resistant plastic material capable of withstanding operating temperatures greater than or equal to 110° C.

In the embodiment shown in the figures, the protection body 7 is rotatably coupled to the protection base 5 and comprises an outlet 24 for the first power cable 17.

Preferably, at the outlet 24, anti-intrusion means 25 configured to prevent the insertion of metal objects inside the protection body 7, have been made.

Metal objects inadvertently inserted into the protection body 7 through the outlet 24 could in fact come dangerously into contact with the conductive elements.

The anti-intrusion means 25 are represented by a pair of walls extending from the respective half-shells 7a, 7b in a direction orthogonal to the longitudinal axis A-A so as to intercept the first power cable 17 and close the access gaps between the first power cable 17 and the opening 24.

At the area where the anti-intrusion means 25 are, some teeth 26 of plastic material for holding the wire can also be provided.

This device 10 for the electrical connection of hair-care household appliances or electrical apparatuses, as is clear from the above description, has the following advantages:
small dimensions;
safety in protecting the female receptacle from the possible contact with the electric wires of the power cable during the assembly of the same device;
increasing the safety of the female receptacle or the male connector against possible voltaic arcs that can be generated inside the same device;
simplicity of construction combined with high reliability;
low and competitive cost;

Several changes can be made to the embodiments described in detail, all anyhow remaining within the protection scope of the invention as defined by the following claims.

1. A device for the electrical connection of hair-care household appliances or electrical apparatuses, comprising:
a female receptacle provided with two seats (8a, 8b) connected electrically to a first power cable by two conductive contact portions of said first cable, which have mutually different electric potential;
a male connector comprising a first electrical contact with a longitudinal axis, comprising a pin, a second electrical contact comprising a tubular element, and a protection base from which the first electrical contact and the second electrical contact extend and are fastened, said protection base being coupled to a second power cable, which is configured to electrically connect said first electrical contact and said second electrical contact;
the first electrical contact and the second electrical contact are concentric to each other and can be removably inserted inside said seats so as to allow the continuous rotation of the male connector with respect to the female receptacle around the longitudinal axis;
a protection body configured to contain said female receptacle and at least partially said male connector; said protection body being rotatably coupled to said protection base and comprising an outlet for said first power cable;
characterised by comprising a barrier element interposed between said pin and said outlet, said barrier element being further interposed in a direction transverse to the longitudinal axis between said pin and one of said conductive contact portions so as to electrically shield at least said pin and at least one of said conductive contact portions with respect to a possible voltaic arc generated therebetween.

2. The device for the electrical connection according to claim 1, characterised in that said barrier element is away from said pin.

3. The device for the electrical connection according to claim 1, characterised in that said barrier element is shaped so as to have a surface of greater vertical extension than that of the pin and the two conductive contact portions.

4. The device for the electrical connection according to claim 1, characterised in that said barrier element (13) comprises a front portion extending transversely to the longitudinal axis.

5. The device for the electrical connection according to claim 4, characterised in that said front portion has a minimum width greater than 3 mm, which is measured along a direction transverse to said longitudinal axis.

6. The device for the electrical connection according to claim 4, characterised in that said front portion is arranged so as to form a concavity facing said pin.

7. The device for the electrical connection according to claim 4, characterised in that said front portion has a minimum height greater than 10 mm.

8. The device for the electrical connection according to claim 4, characterised in that said front portion has a minimum thickness greater than or equal to 0.5 mm.

9. The device for the electrical connection according to claim 4, characterised in that said barrier element comprises a side portion.

10. The device for the electrical connection according to claim 9, characterised in that said side portion extends from one end of said front portion along a direction parallel to said longitudinal axis.

11. The device for the electrical connection according to claim 1, characterised in that said barrier element is made of a heat-resistant insulating plastic material.

12. The device for the electrical connection according to claim 1, characterised by comprising, at the outlet, anti-intrusion means configured to prevent the insertion of metal objects inside the protection body.

13. A hair dryer comprising a device for the electrical connection, the hairdryer comprising:
a female receptacle provided with two seats connected electrically to a first power cable by means of two conductive contact portions of said first cable, which have mutually different electric potential;
a male connector comprising a first electrical contact with a longitudinal axis, comprising a pin, a second electrical contact comprising a tubular element, and a protection base from which the first electrical contact and the second electrical contact extend and are fastened, said protection base being coupled to a second power cable, which is configured to electrically connect said first electrical contact and said second electrical contact;
the first electrical contact and the second electrical contact are concentric to each other and can be removably inserted inside said seats so as to allow the continuous rotation of the male connector with respect to the female receptacle around the longitudinal axis;
a protection body configured to contain said female receptacle and at least partially said male connector; said protection body being rotatably coupled to said protection base and comprising an outlet for said first power cable;
characterised by comprising a barrier element interposed between said pin and said outlet, said barrier element being further interposed in a direction transverse to the longitudinal axis between said pin and one of said conductive contact portions so as to electrically shield at least said pin and at least one of said conductive contact portions with respect to a possible voltaic arc generated therebetween.
